(19) United States
(12) Patent Application Publication
(10) Pub. No.: US 2006/0290734 A1
(43) Pub. Date: Dec. 28, 2006

(54) PRINTING DEVICE INCLUDING HEAD CHIP TO EJECT INK DROPLETS AND METHOD OF ADJUSTING TEMPERATURE OF HEAD CHIP

(76) Inventor: Masahiko HABUKA, Suwon-si (KR)

Correspondence Address: STANZIONE & KIM, LLP, 919 18TH STREET, N.W., SUITE 440, WASHINGTON, DC, 20006, US

(21) Appl. No.: 11/278,739

(22) Filed: Apr. 5, 2006

(30) Foreign Application Priority Data
Jun. 25, 2005 (KR) 2005-55419

(51) Int. Cl. B41J 29/38

(52) U.S. Cl. 347/17; 347/19

(57) ABSTRACT

A printing device that includes an auxiliary heater to heat a head chip and a plurality of temperature sensors to measure a temperature of the head chip. The temperature sensors include a temperature sensor installed near a nozzle nearest to the auxiliary heater and a temperature sensor installed near a nozzle farthest away from the auxiliary heater.

### CROSS-REFERENCE TO RELATED APPLICATIONS

This application claims the benefit of Korean Patent Application No. 2005-55419, filed on 25 Jun. 2005, in the Korean Intellectual Property Office, which is incorporated herein in its entirety by reference.

### BACKGROUND OF THE INVENTION

1. Field of the Invention

The present general inventive concept relates to a printing device that ejects ink droplets and thus prints images, and a method of adjusting the temperature of a head chip included in the printing device.

2. Description of the Related Art

In general, inkjet printers include one or more head chips having a plurality of nozzles and a plurality of main heaters to eject ink through the nozzles. The performance of inkjet printers is dependent upon the viscosity of ink. The viscosity of ink is high at a low temperature and decreases as the temperature increases. Therefore, it is necessary to maintain the temperature of a head chip at a predetermined level to obtain a desired viscosity of ink for optimal printing conditions. For this, a printing device includes an auxiliary heater to heat a head chip and a temperature sensor to measure the temperature of the head chip. The printing device adjusts the temperature of the head chip by measuring the temperature of the head chip after power is applied to the head chip or between printing operations, and by driving an auxiliary heater to heat the head chip if the measured temperature is less than a target temperature.

However, the measured temperature of the head chip may vary according to the location of a temperature sensor in the printing device. In other words, in the case of measuring the temperature of the head chip using a temperature sensor installed near the auxiliary heater, the temperatures of portions of the head chip far away from the auxiliary heater may be less than a target temperature when the result of the temperature sensor's measurement reaches the target temperature. On the other hand, in the case of measuring the temperature of the head chip using a temperature sensor installed far away from the auxiliary heater, the temperature of portions of the head chip near the auxiliary heater may be greater than the target temperature when the result of the temperature sensor's measurement reaches the target temperature. If the temperature of the head chip becomes irregular from region to region, it may be difficult to obtain high quality printed images because of differences in ink ejection properties among nozzles of the head chip.

Head chips included in shuttle-type inkjet heads are about 0.5 inches long, while some head chips included in line inkjet heads are at least 2 inches long. In order to uniformly heat such a long head chip to a target temperature, it is necessary to heat the portion of the head chip near the auxiliary heater to a temperature above the target temperature and wait until the heat is transferred to the portion of the head chip far away from the auxiliary heater and until the temperature of the entire head chip reaches the target temperature. In this case, portions of the head chip near the auxiliary heater are over-heated, thus increasing the possibility of deterioration in the performance of the head chip.

### SUMMARY OF THE INVENTION

The present general inventive concept provides a printing device and a method of adjusting the temperature of a head chip in which the temperature of a head chip can be uniformly adjusted by precisely measuring the temperature of the head chip and driving an auxiliary heater based on the result of the measurement.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a printing device comprising a head chip to eject ink through a plurality of nozzles. The printing device includes: an auxiliary heater to heat the head chip; and a plurality of temperature sensors to measure a temperature of the head chip. The temperature sensors comprise a temperature sensor installed near a nozzle closest to the auxiliary heater and a temperature sensor installed near a nozzle farthest away from the auxiliary heater.

The printing device may also include a plurality of auxiliary heaters, at least one of the plurality of auxiliary heaters being installed at a first end of a nozzle array of the head chip, and at least another of the plurality of auxiliary heaters being installed at a second end of the nozzle array of the head chip.

The foregoing and/or other aspects and utilities of the present general inventive concept may also be achieved by providing a method of adjusting a temperature of a head chip of a printing device, the printing device comprising the head chip to eject ink through a plurality of nozzles, an auxiliary heater to heat the head chip, and a plurality of temperature sensors, the method including determining a plurality of initial temperatures from the head chip using the temperature sensors, determining whether all of the initial temperatures are less than a minimum printing initiation temperature, when all of the initial temperatures are less than the minimum printing initiation temperature, continuously driving the auxiliary heater to heat the head chip, detecting a plurality of temperatures from the head chip using the plurality of temperature sensors, determining whether a maximum temperature among the detected temperatures reaches a predetermined temperature between the minimum printing initiation temperature and a maximum printing initiation temperature, and stopping the continuous driving of the auxiliary heater when the maximum measured temperature is determined to be greater than the predetermined temperature, and intermittently driving the auxiliary heater to heat the head chip until a difference between a maximum temperature and a minimum temperature among the detected temperatures from the head chip is less than or equal to equal to a reference value and until all of the detected temperatures are greater than or equal to the minimum printing initiation temperature.

The foregoing and/or other aspects and utilities of the present general inventive concept may also be achieved by providing a method of adjusting a temperature of a head chip of a printing device, the printing device comprising the head chip to eject ink through a plurality of nozzles, an auxiliary heater to heat the head chip, and a plurality of temperature sensors, the method including detecting a plurality of temperatures from the head chip using the temperature sensors, and when at least one of the detected temperatures is less than a minimum printing initiation temperature, intermittently driving the auxiliary heater until a difference between a maximum temperature and a minimum temperature measured from the head chip is less than or equal to a reference value and until all of the detected temperatures are greater than or equal to the minimum printing initiation temperature.

The foregoing and/or other aspects and utilities of the present general inventive concept may also be achieved by providing a method of adjusting a temperature of a head chip of a printing device, the printing device comprising the head chip to eject ink through a plurality of nozzles, an auxiliary heater to heat the head chip, and a plurality of temperature sensors, the method including detecting a temperature from a plurality of portions of the head chip using the temperature sensors, when all of the detected temperatures are greater than a minimum printing initiation temperature, waiting until the plurality of portions of the head chip cool down such extent that all of the temperature sensors detect a temperature less than or equal to a maximum printing initiation temperature from the head chip, and when the plurality of portions of the head chip are at a temperature such that all of the temperature sensors detect a temperature less than or equal to the maximum printing initiation temperature from the head chip, intermittently driving the auxiliary heater until all of the temperature sensors detect a temperature equal to or greater than the minimum printing initiation temperature from the head chip and until a difference between a maximum temperature and a minimum temperature among the detected temperatures is equal to or smaller than a reference value.

Of the plurality of temperature sensors, one temperature sensor may be located near a first nozzle that is nearest to the auxiliary heater and another temperature sensor may be located near a second nozzle that is farthest away from the auxiliary heater.

The method may also include heating the head chip by driving a plurality of main heaters to eject ink through the nozzles together with the auxiliary heater under a condition that the ink is not ejected.

A distance between a main heater and the auxiliary heater is proportional to a frequency at which the main heater is driven, such that as the distance between the main heater and the auxiliary heater increases, the frequency at which the main heater is driven may correspondingly increase.

The foregoing and/or other aspects and utilities of the present general inventive concept may also be achieved by providing a method of adjusting a temperature of a head chip of a printing device, the printing device comprising the head chip, the head chip comprising a plurality of main heaters to eject ink and an auxiliary heater to heat the head chip, the method including heating the head chip by driving the auxiliary heater, and heating the head chip by driving the plurality of main heaters to eject ink through the nozzles together with the auxiliary heater under a condition that the ink is not ejected.

The foregoing and/or other aspects and utilities of the present general inventive concept may also be achieved by providing a method of adjusting a temperature of a head chip of a printing device, the head chip including at least one auxiliary heater and a plurality of temperature sensors located along a length of the head chip, the method including detecting a plurality initial temperatures T₀ at portions of the head chip corresponding to the plurality of temperature sensors, determining that each of the plurality of initial temperatures T₀ is less than a minimum printing initiation temperature, continuously heating the head chip using the at least one auxiliary heater, detecting a plurality of temperatures T1 at the portions of the head chip corresponding to the plurality of temperature sensors, determining a maximum detected temperature T1ₘₐₓ among the plurality of temperatures T3, determining whether the maximum detected temperature T1ₘₐₓ is greater than a predetermined temperature t2 between the minimum printing initiation temperature and a maximum printing initiation temperature, when the maximum detected temperature T1ₘₐₓ is less than or equal to the predetermined temperature t2, continuing the continuous heating of the head chip until the maximum detected temperature T1ₘₐₓ is greater than the predetermined temperature t2, and when the maximum detected temperature T1ₘₐₓ is greater than the predetermined temperature t2, stopping the continuous heating of the head chip.

The method may further include detecting a plurality of temperatures T3 at the portions of the head chip corresponding to the plurality of temperature sensors, determining a maximum detected temperature T3ₘₐₓ and a minimum detected temperature T3ₘᵢₙ among the plurality of temperatures T3, determining whether a difference between the maximum detected temperature T3ₘₐₓ and the minimum detected temperature T3ₘᵢₙ is less than or equal to a predetermined temperature t3, when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3, and when the difference between the maximum detected temperature T3ₘₐₓ and the minimum detected temperature T3ₘᵢₙ is less than or equal to a predetermined temperature t3, determining whether the minimum detected temperature T3ₘᵢₙ is less than the minimum printing initiation temperature.

The method may further include determining that the minimum detected temperature T3ₘᵢₙ is less than the minimum printing initiation temperature, and intermittently heating the head chip using the at least one auxiliary heater until the difference between the maximum detected temperature T3ₘₐₓ and the minimum detected temperature T3ₘᵢₙ is less than or equal to the predetermined temperature t3, and until the minimum detected temperature T3ₘᵢₙ is greater than or equal to the minimum printing initiation temperature. The method may further include determining that the minimum detected temperature T3ₘᵢₙ is greater than or equal to the minimum printing initiation temperature, and printing an image.

The foregoing and/or other aspects and utilities of the present general inventive concept may also be achieved by providing a method of adjusting a temperature of a head chip of a printing device, the head chip including at least one auxiliary heater and a plurality of temperature sensors located along a length of the head chip, the method including detecting a plurality initial temperatures T₀ at portions of the head chip corresponding to the plurality of temperature sensors, determining that at least one of the plurality of initial temperatures T₀ is greater than or equal to the minimum printing initiation temperature, and determining whether each of the plurality of initial temperatures T₀ is greater than or equal to the minimum printing initiation temperature.

The method may further include determining that at least one of the plurality of initial temperatures T₀ is less than the minimum printing initiation temperature, detecting a plurality of temperatures T3 at portions of the head chip corresponding to the plurality of temperature sensors, determining a maximum detected temperature T3ₘₐₓ and a minimum detected temperature T3ₘᵢₙ among the plurality of temperatures T3, determining whether a difference between the maximum detected temperature T3ₘₐₓ and the minimum detected temperature T3ₘᵢₙ is less than or equal to a predetermined temperature t3, when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3, and when the difference between the maximum detected temperature T3ₘₐₓ and the minimum detected temperature T3ₘᵢₙ is less than or equal to the predetermined temperature t3, determining whether the minimum detected temperature T3ₘᵢₙ is less than the minimum printing initiation temperature.

The method may further include determining that the minimum detected temperature T3ₘᵢₙ is less than the minimum printing initiation temperature, and intermittently heating the head chip using the at least one auxiliary heater until the difference between the maximum detected temperature T3ₘₐₓ and the minimum detected temperature T3ₘᵢₙ is less than or equal to the predetermined temperature t3, and until the minimum detected temperature T3ₘᵢₙ is greater than or equal to the minimum printing initiation temperature. The method may further include determining that the minimum detected temperature T3ₘᵢₙ is greater than or equal to the minimum printing initiation temperature, and printing an image.

The method may further include determining that each of the plurality of initial temperatures T₀ is greater than or equal to the minimum printing initiation temperature, determining whether each of the initial temperatures T₀ is less than or equal to a maximum printing initiation temperature, when at least one of the initial temperatures T₀ is greater than the maximum printing initiation temperature, waiting until each of the initial temperatures T₀ is less than or equal to a maximum printing initiation temperature, and when each of the initial temperatures T₀ is less than or equal to a maximum printing initiation temperature, detecting a plurality of temperatures T3 at portions of the head chip corresponding to the plurality of temperature sensors, determining a maximum detected temperature T3ₘₐₓ and a minimum detected temperature T3ₘᵢₙ among the plurality of temperatures T3, determining whether a difference between the maximum detected temperature T3ₘₐₓ and the minimum detected temperature T3ₘᵢₙ is less than or equal to a predetermined temperature t3, when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3, and when the difference between the maximum detected temperature T3ₘₐₓ and the minimum detected temperature T3ₘᵢₙ is less than or equal to a predetermined temperature t3, determining whether the minimum detected temperature T3ₘᵢₙ is less than the minimum printing initiation temperature.

The foregoing and/or other aspects and utilities of the present general inventive concept may also be achieved by providing a printing device head chip including at least one nozzle array, at least one auxiliary heater located at one end of the at least one nozzle array, and a plurality of temperature sensors uniformly distributed along a length of the head chip.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a printing device adopting a line inkjet head according to an embodiment of the present general inventive concept;

FIG. 2 is a diagram illustrating a printing device adopting a shuttle-type inkjet head according to an embodiment of the present general inventive concept;

FIG. 3 is a cross-sectional view of a head chip according to an embodiment of the present general inventive concept;

FIG. 4 is a diagram illustrating a structure of a head chip according to an embodiment of the present general inventive concept in which an auxiliary heater and a plurality of temperature sensors are arranged;

FIG. 5 is a diagram illustrating a structure of a head chip according to another embodiment of the present general inventive concept in which two auxiliary heaters and a plurality of temperature sensors are arranged;

FIG. 6 is a diagram illustrating waveforms of main heater driving signals of the head chips of FIGS. 4 and 5;

FIG. 7 is a diagram illustrating temperature distributions along a longitudinal direction of the head chips of FIGS. 4 and 5;

FIG. 8 is a diagram illustrating frequency patterns of main heater driving signals of the head chips of FIGS. 4 and 5;

FIG. 9 is a flowchart illustrating a method of adjusting a temperature of a head chip according to an embodiment of the present general inventive concept;

FIG. 10 is a diagram illustrating a waveform of an auxiliary heater driving signal; and

FIG. 11 is a block diagram of an apparatus to adjust a temperature of a head chip according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

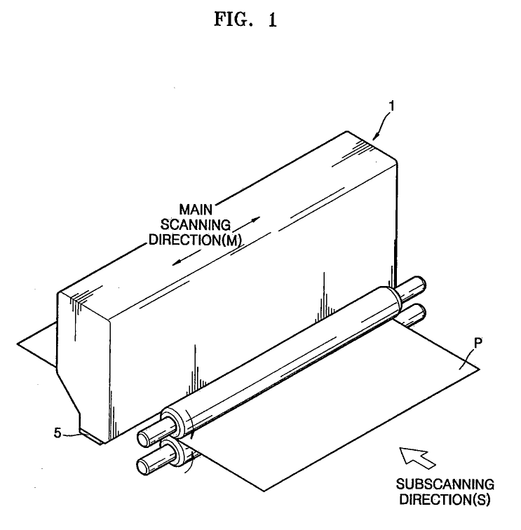

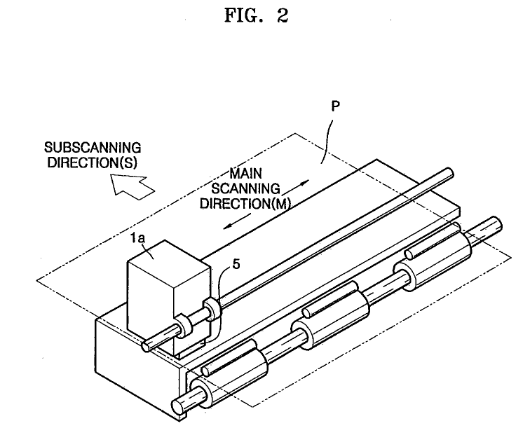

FIGS. 1 and 2 are diagrams illustrating printing devices according to embodiments of the present general inventive concept. Referring to FIG. 1, paper P is transmitted in a sub-scanning direction S, and an inkjet head 1 fixedly installed above the paper P prints an image on the paper P by ejecting ink onto the paper P. Referring to FIG. 2, paper P is transferred along a sub-scanning direction S, and an inkjet head 1a prints an image on the paper P by ejecting ink onto the paper P while moving back and forth in a main scanning direction M. The inkjet head 1a is referred to as a shuttle-type inkjet head, and the inkjet head 1 is referred to as a line inkjet head. The inkjet head 1a, which can be used for printing unicolored images, includes a head chip 5 having a length of about 0.5 inches. On the other hand, the inkjet head 1, which can be used for printing unicolored images on A4-sized paper, includes 4 or 5 head chips 5 each having a length of, for example, about 2 inches, arranged in series in the main scanning direction M.

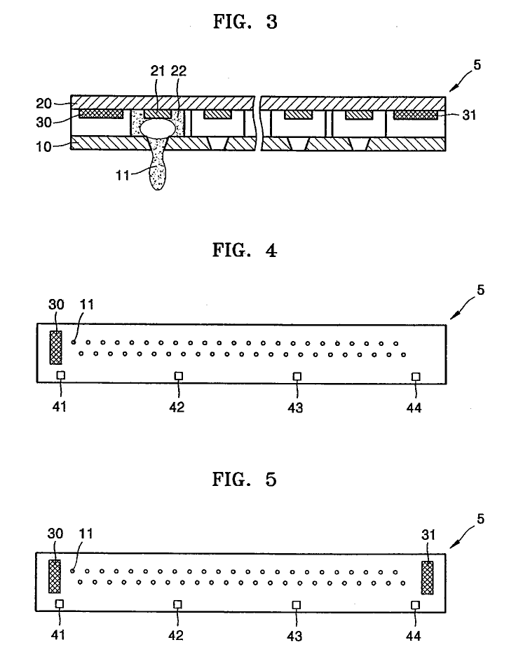

FIG. 3 is a cross-sectional view of a head chip 5 according to an exemplary embodiment of the present general inventive concept. Referring to FIG. 3, the head chip 5 includes a plurality of nozzles 11 through which ink is ejected and a plurality of main heaters 21 to heat the ink. The nozzles 11 are formed on a nozzle plate 10. The main heaters 21 are located on a substrate 20. An ink passage (not illustrated) through which ink is transferred from an ink container (not illustrated) to a chamber 22 is formed between the nozzle plate 10 and the substrate 20. When a voltage is applied to the main heaters 21, the ink contained in the chamber 22 is heated, and bubbles in the ink rapidly expand. Due to an expansive pressure of these bubbles, the ink contained in the chamber 22 is ejected through the nozzles 11.

In order to initiate a printing operation, a head chip, such as the head chip 5 illustrated in FIG. 3, must be heated to a temperature between a minimum printing initiation temperature t1 and a maximum printing initiation temperature t4, inclusive of the minimum printing initiation temperature t1 and the maximum printing initiation temperature t4. Referring to FIG. 4, in order to adjust the temperature of a head chip 5, a printing device according to an embodiment of the present general inventive concept includes an auxiliary heater 30 and a plurality of temperature sensors 41, 42, 43, and 44. The auxiliary heater 30 may be formed on a substrate 20. It is difficult to install the auxiliary heater 30 between nozzles 11 because of spatial restrictions imposed by an arrangement of the nozzles 11, and thus, the auxiliary heater 30 is installed on one side of the head chip 5, as illustrated in FIG. 4. The temperature sensors 41, 42, 43, and 44 are arranged in series along a longitudinal direction of the head chip 5. At least one temperature sensor 41 of the plurality of temperature sensors is located near the auxiliary heater 30, and at least one temperature sensor 44 of the plurality of temperature sensors is located far away from the auxiliary heater 30. Therefore, the temperature sensors 41, 42, 43, and 44 can not only measure temperatures of portions of the head chip 5 in the vicinity of the auxiliary heater 30, but can also measure temperatures of portions of the head chip 5 apart from the auxiliary heater 30.

FIG. 11 is a block diagram of an apparatus to adjust a temperature of a head chip 5 according to an exemplary embodiment of the present general inventive concept. Referring to FIG. 11, temperatures measured by temperature sensors 41, 42, 43, and 44 are input to a central processing unit (CPU) 50 via, for example, an analog-to-digital (A/D) converter 51. A maximum printing initiation temperature t1, a minimum printing initiation temperature t4, and a predetermined temperature t2 between the maximum and minimum printing initiation temperatures t1 and t4 are set in advance in a memory 52. The CPU 50 controls an auxiliary heater driving circuit 53 and a main heater driving circuit 54 to drive an auxiliary heater 30 and a main heater 21, respectively.

The temperature sensors 41, 42, 43, and 44 measure the temperature of the head chip 5 while the auxiliary heater 30 heats the head chip 5. A temperature of a portion of the head chip 5 corresponding to the temperature sensor 41 is expected to exceed the minimum printing initiation temperature t1 and to reach the predetermined temperature t2 first, as the temperature sensor 41 is closer to the auxiliary heater 30 than each of the temperature sensors 42-44. It takes time to transmit heat emitted by the auxiliary heater 30 from the portion of the head chip 5 corresponding to the temperature sensor 41 to a portion of the head chip 5 corresponding to the temperature sensor 44. Thus, the temperature of the portion of the head chip 5 corresponding to the temperature sensor 44 may not have reached the minimum printing initiation temperature t1 when the portion of the head chip 5 corresponding to the temperature sensor 41 has reached the minimum printing initiation temperature t1 much earlier. If the temperature of the portion of the head chip 5 corresponding to the temperature sensor 41 is between the minimum printing initiation temperature t1 and the maximum printing initiation temperature t4, the apparatus stops driving the auxiliary heater 30 and waits until heat emitted by the auxiliary heater 30 is transmitted to the entire head chip 5. Thereafter, the apparatus measures the temperatures of the head chip 5 measured by the temperature sensors 41, 42, 43, and 44 and again drives the auxiliary heater 30 to heat the head chip 5 if any of the measured temperatures is between the minimum printing initiation temperature t1 and the maximum printing initiation temperature t4. The auxiliary heater 30 is driven in such a manner that none of the measured temperatures is greater than the maximum printing initiation temperature t4. By repeating this operation, the apparatus can uniformly adjust the temperature of the head chip 5 to be between the minimum printing initiation temperature t1 and the maximum printing initiation temperature t4. In addition, the apparatus can measure the temperatures of portions of the head chip 5 apart from the auxiliary heater 30, thus preventing the head chip 5 from being over-heated by excessively driving the auxiliary heater 30.

FIG. 5 is a diagram illustrating a structure of a head chip 5 according to another exemplary embodiment of the present general inventive concept in which two auxiliary heaters 30 and 31 and a plurality of temperature sensors 41, 42, 43, and 44 are arranged. Referring to FIG. 5, the auxiliary heaters 30 and 31 are arranged at opposite ends of the head chip 5. Of the temperature sensors 41 and 42, the temperature sensor 42 is farthest away from the auxiliary heater 30, and of the temperature sensors 43 and 44, the temperature sensor 43 is farthest away from the auxiliary heater 31. Therefore, the temperature sensors 41 and 42 are considerably affected by the auxiliary heater 30, and the temperature sensors 43 and 44 are considerably affected by the auxiliary heater 31

In order to heat the head chip 5 to a temperature between a minimum printing initiation temperature t1 and a maximum printing initiation temperature t4, the auxiliary heaters 30 and 31 may be driven together with a main heater 21. When driving the main heater 21, a waveform of a main heater driving signal must be adjusted to prevent ink from being ejected. In other words, referring to FIG. 6, duty d of the main heater driving signal is set lower than duty di required to eject the ink. Thus, the head chip 5 can be heated using the main heater 21 while preventing ink from being ejected. In this manner, the head chip 5 can be rapidly heated to a temperature between the minimum printing initiation temperature t1 and the maximum printing initiation temperature t4.

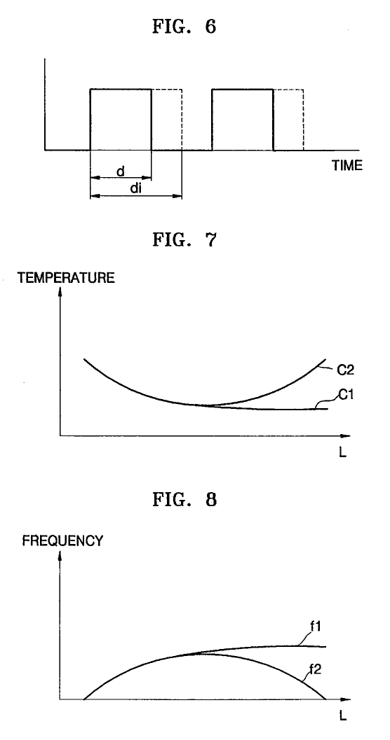

A frequency of the main heater driving signal may be adjusted for portions of the head chip 5 in consideration of distances between the portions of the head chip 5 and the auxiliary heater 30 or 31, thereby quickly and efficiently heating the head chip 5 to a temperature between the minimum printing initiation temperature t1 and the maximum printing initiation temperature t4. When heating the head chip 5 using the single auxiliary heater 30, as illustrated in FIG. 4, a temperature distribution along a longitudinal direction of the head chip 5 may be represented by a curve C1 as illustrated in FIG. 7. In this case, the farther a portion of the head chip 5 is away from the auxiliary heater 30, the lower the temperature of the portion of the head chip 5. Thus, the main heater driving signal is set to have a predetermined frequency distribution pattern that may be represented by a curve f1 as illustrated in FIG. 8, so the frequency of the main heater driving signal is higher for the portions of the head chip 5 farther away from the auxiliary heater 30.

On the other hand, when heating the head chip 5 using the two auxiliary heaters 30 and 31, as illustrated in FIG. 5, the temperature distribution in the head chip 5 along the longitudinal direction of the head chip 5 may be represented as a curve C2 as illustrated in FIG. 7. In this case, the main heater driving signal is set to have a predetermined frequency distribution pattern that can be represented by a curve f2 as illustrated in FIG. 8. By setting the main heater driving signal to have the predetermined frequency distribution pattern of FIG. 8, it is possible to uniformly heat the head chip 5 to a temperature between the minimum printing initiation temperature t1 and the maximum printing initiation temperature t4. The predetermined frequency distribution pattern of the main heater driving signal as illustrated in FIG. 8 may be stored in a memory, such as the memory 52 illustrated in FIG. 11, of a printing device.

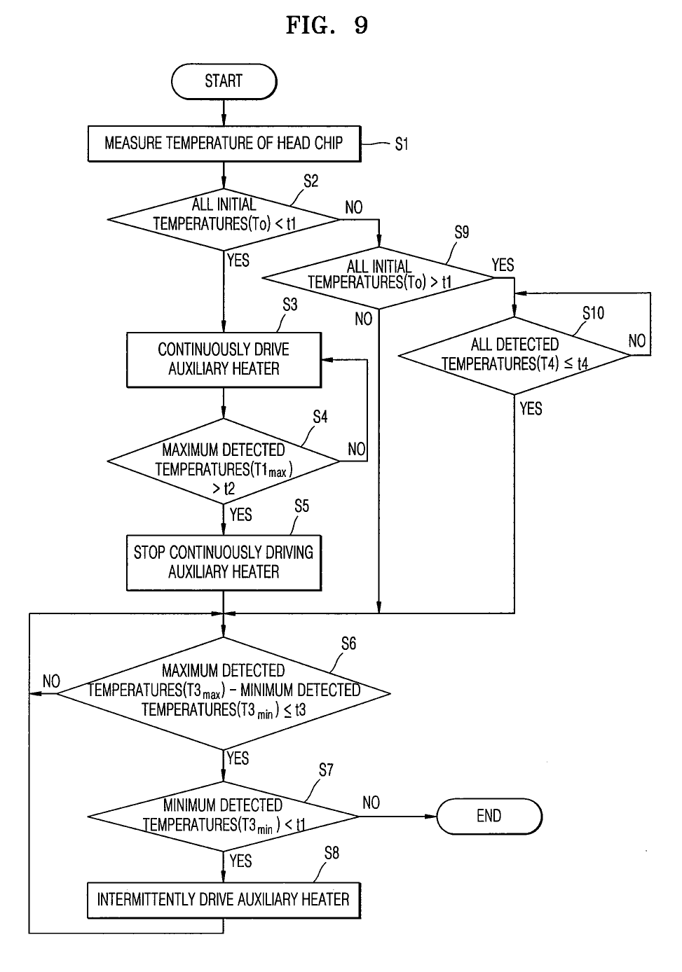

A method of adjusting a temperature of a head chip 5 according to an exemplary embodiment of the present general inventive concept will now be described in detail with reference to FIG. 9. The adjustment of the temperature of the head chip 5 may be carried out when a printing device having the head chip 5 is turned on, when a print command is received from a host (not illustrated), or between printing operations.

Referring to FIG. 9 with reference to FIG. 5, in operation S1, the temperature of the head chip 5 is measured by the temperature sensors 41, 42, 43, and 44. In operation S2, results of the temperature measurements, i.e., initial temperatures T0, are compared with a minimum printing initiation temperature t1. Thereafter, as discussed separately below, different processes may be carried out according to whether all of the initial temperatures T0 are less than the minimum printing initiation temperature t1.

Adjustment of Temperature of Head Chip When All Initial Temperatures T0 are Less than Minimum Printing Initiation Temperature t1

When all of the initial temperatures T0 are less than the minimum printing initiation temperature t1, there is a need to quickly increase the temperature of the head chip 5. Therefore, in operation S3, the auxiliary heaters 30 and 31 are continuously driven. The continuous driving of the auxiliary heaters 30 and 31 in operation S3 may be carried out by continuously applying an auxiliary heater driving signal to the auxiliary heaters 30 and 31. In operation S4, while the auxiliary heaters 30 and 31 heat the head chip 5, the temperature sensors 41, 42, 43, and 44 re-measure the temperature of the head chip 5. In operation S5, if a maximum temperature T1ₘₐₓ among the re-measurement results obtained in operation S4 is greater than a predetermined temperature t2 (which is between the minimum printing initiation temperature t1 and the maximum printing initiation temperature t4), the auxiliary heaters 30 and 31 stop heating the head chip 5 to prevent the head chip 5 from being over-heated. It is expected that the temperature of the head chip 5 will be greater for portions of the head chip 5 closer to one of the auxiliary heaters 30 or 31.

Thereafter, predetermined processes are carried out until a difference between a maximum temperature and a minimum temperature measured from the head chip 5 by the temperature sensors 41, 42, 43, and 44 is less than or equal to a reference value t3 and until the minimum measured temperature is greater than or equal to the minimum printing initiation temperature t1. The reference value t3 may be set as a temperature not greater than the difference between the maximum printing initiation temperature t4 and the minimum printing initiation temperature t1. While the temperature sensors 41, 42, 43, and 44 continue to measure the temperature of the head chip 5 without further heating the head chip 5 using the auxiliary heaters 30 and 31, it is determined in operation S6 whether a difference between a maximum measured temperature T3ₘₐₓ and a minimum measured temperature T3ₘᵢₙ among the results of the continued temperature measurements is equal to or less than the reference value t3.

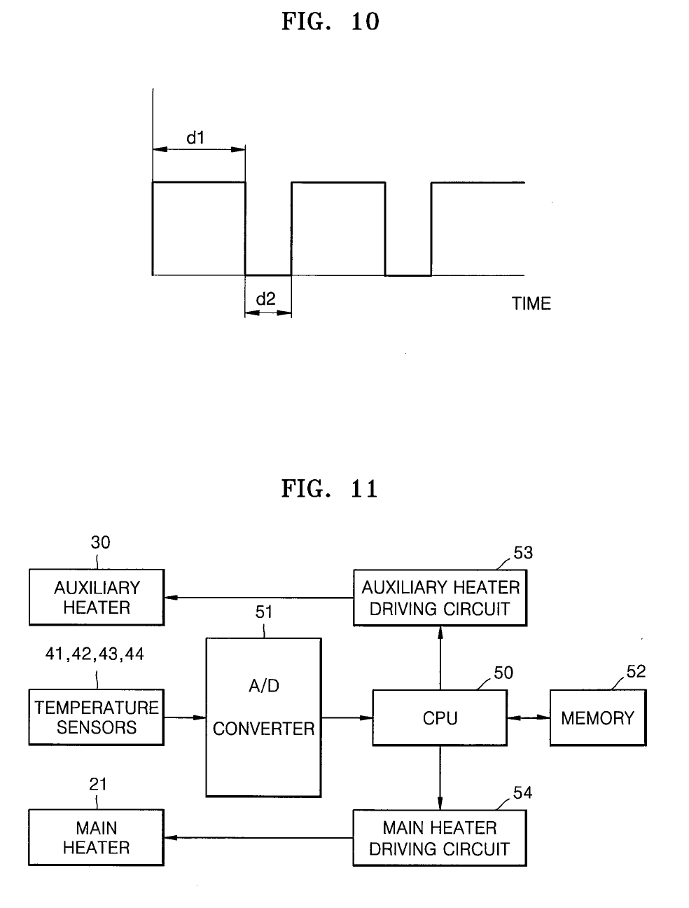

In operation S7, if the difference between the maximum measured temperature T3ₘₐₓ and the minimum measured temperature T3ₘᵢₙ is determined to be equal to or less than the reference value t3 in operation S6, it is then determined whether the minimum measured temperature T3ₘᵢₙ is equal to or greater than the minimum printing initiation temperature t1. If the minimum measured temperature T3ₘᵢₙ is greater than the minimum printing initiation temperature t1, the adjustment of the temperature of the head chip 5 is terminated, and the head chip 5 becomes ready to perform a print operation in response to a print command. On the other hand, if the minimum measured temperature T3ₘᵢₙ is less than the minimum printing initiation temperature t1, the auxiliary heaters 30 and 31 are intermittently driven to intermittently heat the head chip 5. The intermittent driving of the auxiliary heaters 30 and 31 may be carried out by applying to the auxiliary heaters 30 and 31 a pulse type auxiliary heater driving signal as illustrated in FIG. 10.

Referring to FIG. 10, reference numeral d1 is a time period during which the auxiliary heaters 30 and 31 are driven to further heat the head chip 5, and reference numeral d2 is a time period during which the auxiliary heaters 30 and 31 are not driven to further heat the head chip 5, but rather wait until heat emitted by the auxiliary heaters 30 and 31 during the time period d1 is transmitted throughout the entire head chip 5. Durations of the time periods d1 and d2 may be appropriately determined in consideration of a thermal conductivity of the head chip 5 and a calorific value of the auxiliary heaters 30 and 31. The auxiliary heaters 30 and 31 are intermittently driven in operation S8 to heat the head chip 5, thereby uniformly increasing the temperature of the head chip 5 while preventing the head chip 5 from being over-heated and damaged.

While the auxiliary heaters 30 and 31 are intermittently driven to heat the head chip 5, the temperature sensors 41, 42, 43, and 44 continue to measure the temperature of the head chip 5. It is subsequently determined whether a difference between the maximum temperature T3ₘₐₓ and the minimum temperature T3ₘᵢₙ measured from the head chip 5 is equal to or less than the reference value t3. If the difference between the subsequently-determined maximum measured temperature T3ₘₐₓ and the subsequently-determined minimum measured temperature T3ₘᵢₙ is less than or equal to the reference value t3, then it is further determined whether the minimum measured temperature T3ₘᵢₙ is equal to or greater than the minimum printing initiation temperature t1. Accordingly, it is possible to effectively adjust the temperature of the head chip 5 by repeatedly performing operations S6, S7, and S8 until a difference between the maximum temperature T3ₘₐₓ and the minimum temperature T3ₘᵢₙ measured from the head chip 5 is less than or equal to the reference value t3, and until the minimum measured temperature T3ₘᵢₙ is greater than or equal to the minimum printing initiation temperature t1.

Adjustment of Temperature of Head Chip when Only Some Initial Temperatures T₀ are Less than Minimum Printing Initiation Temperature t1

In operation S9, it is determined whether all of the initial temperatures T₀ are greater than or equal to the minimum printing initiation temperature t1. If only some of the initial temperatures To are greater than or equal to the minimum printing initiation temperature t1, the temperature of the head chip 5 may not need to be increased as quickly as when none of the initial temperatures To are greater than the minimum printing initiation temperature t1. Thus, when only some of the initial temperatures To are greater than or equal to the minimum printing initiation temperature t1, operations S3, S4, and S5 (in which the auxiliary heaters 30 and 31 are continuously driven until at least one of the temperature sensors 41, 42, 43, and 44 detects a temperature greater than the predetermined temperature t2) are skipped, and operations S6, S7, and S8 (in which the auxiliary heaters 30 and 31 are intermittently driven until a difference between a maximum temperature T3ₘₐₓ and a minimum temperature T3ₘᵢₙ measured from the head chip 5 becomes less than or equal to the reference value t3 and until the minimum measured temperature T3ₘᵢₙ becomes greater than or equal to the minimum printing initiation temperature t1) are carried out.

Adjustment of Temperature of Head Chip when All Initial Temperatures T0 are Greater than Minimum Printing Initiation Temperature t1

When all of the initial temperatures To are determined to be greater than the minimum printing initiation temperature t1, some of the initial temperatures To may be greater than the maximum printing initiation temperature t4. Thus, when all of the initial temperatures To are determined to be greater than the minimum printing initiation temperature t1, the method proceeds to operation S10, instead of operation S6, in order to prevent the head chip 5 from being over-heated. In operation S10, the auxiliary heaters 30 and 31 are not driven to heat the head chip 5, and the temperature sensors 41, 42, 43, and 44 measure the temperature of the head chip 5. Since the auxiliary heaters 30 and 31 are not driven, warmest portions of the head chip 5 gradually cool down because of heat transmission and relatively cool air surrounding the head chip 5. If all of the results of the temperature measurement obtained in operation S10 are determined to be less than or equal to the maximum printing initiation temperature t4, the method proceeds to operation S6, and operations S6, S7, and S8 are repeatedly performed until the difference between the maximum temperature T3ₘₐₓ and the minimum temperature T3ₘᵢₙ measured from the head chip 5 is less than or equal to the reference value t3 and until the minimum measured temperature T3ₘᵢₙ is greater than or equal to the minimum printing initiation temperature t1.

The method of adjusting the temperature of a head chip as illustrated in FIG. 9 has been described as being applied to the head chip 5 including two auxiliary heaters 30 and 31as illustrated in FIG. 5. However, the method of adjusting the temperature of a head chip as illustrated in FIG. 9 can also be applied to the head chip 5 including only one auxiliary heater 30, as illustrated in FIG. 4, or to a head chip including three or more auxiliary heaters.

In operations S5 and S8 of FIG. 9, the head chip 5 can be heated not only by using the auxiliary heaters 30 and 31 but also by using the main heater 21, thereby quickly heating the head chip 5 to a target temperature. In this case, the duty d of the main heater driving signal is determined to be lower than the duty di required to eject the ink. In addition, the frequency of the main heater driving signal is greater for portions of the head chip 5 farther from the auxiliary heater 30 or 31, thereby uniformly adjusting the temperature of the head chip 5.

As described above, according to the present general inventive concept, it is possible to prevent print quality from deteriorating due to differences between temperatures of portions of a head chip by precisely measuring the temperatures of the portions of the head chip and uniformly adjusting the temperature of the head chip based on the results of the temperature measurements. In addition, it is possible to quickly and uniformly increase the temperature of the head chip by using auxiliary heaters and also using a main heater. Therefore, it is possible to make the head chip ready to print data within a relatively short period of time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printing device comprising a head chip to eject ink through a plurality of nozzles, the printing device comprising:
an auxiliary heater to heat the head chip; and
a plurality of temperature sensors to measure a temperature of the head chip, the plurality of temperature sensors comprising a temperature sensor installed near a nozzle closest to the auxiliary heater and a temperature sensor installed near a nozzle farthest away from the auxiliary heater.

2. The printing device of claim 1, further comprising a plurality of auxiliary heaters, at least one of the plurality of auxiliary heaters being installed at a first end of a nozzle array of the head chip, and at least another of the plurality of auxiliary heaters being installed at a second end of the nozzle array of the head chip.

3. A method of adjusting a temperature of a head chip of a printing device, the printing device comprising the head chip to eject ink through a plurality of nozzles, an auxiliary heater to heat the head chip, and a plurality of temperature sensors, the method comprising:
determining a plurality of initial temperatures from the head chip using the temperature sensors;
determining whether all of the initial temperatures are less than a minimum printing initiation temperature;
when all of the initial temperatures are less than the minimum printing initiation temperature, continuously driving the auxiliary heater to heat the head chip, detecting a plurality of temperatures from the head chip using the plurality of temperature sensors, determining whether a maximum temperature among the detected temperatures reaches a predetemined temperature between the minimum printing initiation temperature and a maximum printing initiation temperature, and stopping the continuous driving of the auxiliary heater when the maximum measured temperature is determined to be greater than the predetermined temperature; and
intermittently driving the auxiliary heater to heat the head chip until a difference between the maximum temperature and a minimum temperature among the detected temperatures from the head chip is less than or equal to a reference value and until all of the detected temperatures are greater than or equal to the minimum printing initiation temperature.

4. The method of claim 3, further comprising intermittently driving the auxiliary heater when at least one of the initial temperatures is less than the minimum printing initiation temperature.

5. The method of claim 4 further comprising, waiting until temperatures less than the maximum printing initiation temperature are detected from the head chip by all of the temperature sensors, and intermittently driving the auxiliary heater.

6. The method of claim 5, wherein one temperature sensor is located near a first nozzle that is nearest to the auxiliary heater and another temperature sensor is located near a second nozzle that is farthest away from the auxiliary heater.

7. The method of claim 6, further comprising heating the head chip by driving a plurality of main heaters to eject ink through the nozzles together with the auxiliary heater under a condition that the ink is not ejected.

8. The method of claim 7, wherein a distance between a main heater and the auxiliary heater is proportional to a frequency at which the main heater is driven, such that as the distance between the main heater and the auxiliary heater increases, the frequency at which the main heater is driven correspondingly increases.

9. The method of claim 3, wherein one temperature sensor is located near a first nozzle that is nearest to the auxiliary heater and another temperature sensor is located near a second nozzle that is farthest away from the auxiliary heater

10. The method of claim 3, further comprising heating the head chip by driving a plurality of main heaters to eject ink through the nozzles together with the auxiliary heater under a condition that the ink is not ejected.

11. The method of claim 10, wherein a distance between a main heater and the auxiliary heater is proportional to a frequency at which the main heater is driven, such that as the distance between the main heater and the auxiliary heater increases, the frequency at which the main heater is driven correspondingly increases.

12. A method of adjusting a temperature of a head chip of a printing device, the printing device comprising the head chip to eject ink through a plurality of nozzles, an auxiliary heater to heat the head chip, and a plurality of temperature sensors, the method comprising:
detecting a plurality of temperatures from the head chip using the temperature sensors; and
when at least one of the detected temperatures is less than a minimum printing initiation temperature, intermittently driving the auxiliary heater until a difference between a maximum temperature and a minimum temperature measured from the head chip is less than or equal to a reference value and until all of the detected temperatures are greater than or equal to the minimum printing initiation temperature.

13. The method of claim 12, wherein one temperature sensor is located near a first nozzle that is nearest to the auxiliary heater and another temperature sensor is located near a second nozzle that is farthest away from the auxiliary heater.

14. The method of claim 12, further comprising heating the head chip by driving a plurality of main heaters to eject ink through the nozzles together with the auxiliary heater under a condition that the ink is not ejected.

15. The method of claim 14, wherein a distance between a main heater and the auxiliary heater is proportional to a frequency at which the main heater is driven, such that as the distance between the main heater and the auxiliary heater increases, the frequency at which the main heater is driven correspondingly increases.

16. A method of adjusting a temperature of a head chip of a printing device, the printing device comprising the head chip to eject ink through a plurality of nozzles, an auxiliary heater to heat the head chip, and a plurality of temperature sensors, the method comprising:
detecting a temperature from a plurality of portions of the head chip using the temperature sensors;
when all of the detected temperatures are greater than a minimum printing initiation temperature, waiting until the portions of the head chip cool down such that all of the temperature sensors detect a temperature less than or equal to a maximum printing initiation temperature from the head chip; and
when the portions of the head chip are at a temperature such that all of the temperature sensors detect a temperature less than or equal to the maximum printing initiation temperature from the head chip, intermittently driving the auxiliary heater until all of the temperature sensors detect a temperature equal to or greater than the minimum printing initiation temperature from the head chip and until a difference between a maximum temperature and a minimum temperature among the detected temperatures is less than or equal to a reference value.

17. The method of claim 16, wherein one temperature sensor is located near a first nozzle that is nearest to the auxiliary heater and another temperature sensor is located near a second nozzle that is farthest away from the auxiliary heater.

18. The method of claim 16, further comprising heating the head chip by driving a plurality of main heaters to eject ink through the nozzles together with the auxiliary heater under a condition that the ink is not ejected.

19. The method of claim 18, wherein a distance between a main heater and the auxiliary heater is proportional to a frequency at which the main heater is driven, such that as the distance between the main heater and the auxiliary heater increases, the frequency at which the main heater is driven correspondingly increases

20. A method of adjusting a temperature of a head chip of a printing device, the printing device comprising the head chip, the head chip comprising nozzles, a plurality of main heaters to eject ink and an auxiliary heater to heat the head chip, the method comprising:
heating the head chip by driving the auxiliary heater; and
heating the head chip by driving the plurality of main heaters to eject the ink through the nozzles together with the auxiliary heater under a condition that the ink is not ejected.

21. The method of claim 20, wherein a distance between a main heater and the auxiliary heater is proportional to a frequency at which the main heater is driven, such that as the distance between the main heater and the auxiliary heater increases, the frequency at which the main heater is driven correspondingly increases.

22. A method of adjusting a temperature of a head chip of a printing device, the head chip comprising at least one auxiliary heater and a plurality of temperature sensors located along a length of the head chip, the method comprising:
detecting a plurality initial temperatures T₀ at portions of the head chip corresponding to the plurality of temperature sensors;
determining whether each of the plurality of initial temperatures T₀ is less than a minimum printing initiation temperature;
continuously heating the head chip using the at least one auxiliary heater;
detecting a plurality of temperatures T1 at the portions of the head chip corresponding to the plurality of temperature sensors;
determining a maximum detected temperature T1ₘₐₓ among the plurality of temperatures T3;
determining whether the maximum detected temperature T1ₘₐₓ is greater than a predetermined temperature t2 between the minimum printing initiation temperature and a maximum printing initiation temperaure;
when the maximum detected temperature T1ₘₐₓ is less than or equal to the predetermined temperature t2, continuing the continuous heating of the head chip until the maximum detected temperature T1ₘₐₓ is greater than the predetermined temperature t2; and
when the maximum detected temperature T1ₘₐₓ is greater than the predetermined temperature t2, stopping the continuous heating of the head chip.

23. The method of claim 22, further comprising:
detecting a plurality of temperatures T3 at the portions of the head chip corresponding to the plurality of temperature sensors;
determining a maximum detected temperature T3ₘₐₓ and a minimum detected temperature T3ₘᵢₙ among the plurality of temperatures T3;
determining whether a difference between the maximum detected temperature T3ₘₐₓ and the minimum detected temperature T3ₘᵢₙ is less than or equal to a predetermined temperature t3;
when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3; and
when the difference between the maximum detected temperature T3ₘₐₓ and the minimum detected temperature T3ₘᵢₙ is less than or equal to a predetermined temperature t3, determining whether the minimum detected temperature T3ₘᵢₙ is less than the minimum printing initiation temperature.

24. The method of claim 23, further comprising:
determining that the minimum detected temperature T3ₘᵢₙ is less than the minimum printing initiation temperature; and
intermittently heating the head chip using the at least one auxiliary heater until the difference between the maximum detected temperature T3ₘₐₓ and the minimum detected temperature T3ₘᵢₙ is less than or equal to the predetermined temperature t3, and until the minimum detected temperature T3ₘᵢₙ is greater than or equal to the minimum printing initiation temperature.

25. The method of claim 23, further comprising:
determining that the minimum detected temperature T3ₘᵢₙ is greater than or equal to the minimum printing initiation temperature; and
printing an image.

26. A method of adjusting a temperature of a head chip of a printing device, the head chip comprising at least one auxiliary heater and a plurality of temperature sensors located along a length of the head chip, the method comprising:
detecting a plurality initial temperatures T₀ at portions of the head chip corresponding to the plurality of temperature sensors;
determining that at least one of the plurality of initial temperatures T₀ is greater than or equal to the minimum printing initiation temperature; and
determining whether each of the plurality of initial temperatures T₀ is greater than or equal to the minimum printing initiation temperature.

27. The method of claim 26, further comprising:
determining that at least one of the plurality of initial temperatures T₀ is less than the minimum printing initiation temperature;
detecting a plurality of temperatures T3 at portions of the head chip corresponding to the plurality of temperature sensors;
determining a maximum detected temperature T3ₘₐₓ and a minimum detected temperature T3ₘᵢₙ among the plurality of temperatures T3;
determining whether a difference between the maximum detected temperature T3ₘₐₓ and the minimum detected temperature T3ₘᵢₙ is less than or equal to a predetermined temperature t3;
when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3; and
when the difference between the maximum detected temperature T3ₘₐₓ and the minimum detected temperature T3ₘᵢₙ is less than or equal to the predetermined temperature t3, determining whether the minimum detected temperature T3ₘᵢₙ is less than the minimum printing initiation temperature.

28. The method of claim 27, further comprising:
determining that the minimum detected temperature T3ₘᵢₙ is less than the minimum printing initiation temperature; and
intermittently heating the head chip using the at least one auxiliary heater until the difference between the maximum detected temperature T3ₘₐₓ and the minimum detected temperature T3ₘᵢₙ is less than or equal to the predetermined temperature t3, and until the minimum detected temperature T3ₘᵢₙ is greater than or equal to the minimum printing initiation temperature.

29. The method of claim 27, further comprising:
determining that the minimum detected temperature T3ₘᵢₙ is greater than or equal to the minimum printing initiation temperature; and
printing an image.

30. The method of claim 26, further comprising:
determining that each of the plurality of initial temperatures T₀ is greater than or equal to the minimum printing initiation temperature;
determining whether each of the initial temperatures T₀ is less than or equal to a maximum printing initiation temperature;
when at least one of the initial temperatures T₀ is greater than the maximum printing initiation temperature, waiting until each of the initial temperatures T₀ is less than or equal to a maximum printing initiation temperature; and
when each of the initial temperatures T₀ is less than or equal to a maximum printing initiation temperature,
detecting a plurality of temperatures T3 at portions of the head chip corresponding to the plurality of temperature sensors;
determining a maximum detected temperature T3ₘₐₓ and a minimum detected temperature T3ₘᵢₙ among the plurality of temperatures T3;
determining whether a difference between the maximum detected temperature T3ₘₐₓ and the minimum detected temperature T3ₘᵢₙ is less than or equal to a predetermined temperature t3;
when the difference between the maximum detected temperature T3ₘₐₓ and the minimum detected temperature T3ₘᵢₙ is greater than the predetermined temperature t3, waiting until the difference between the maximum detected temperature T3ₘₐₓ and the minimum detected temperature T3ₘᵢₙ is less than or equal to the predetermined temperature t3; and
when the difference between the maximum detected temperature T3ₘₐₓ and the minimum detected temperature T3ₘᵢₙ is less than or equal to a predetermined temperature t3, determining whether the minimum detected temperature T3ₘᵢₙ is less than the minimum printing initiation temperature.

31. The method of claim 30, further comprising:
determining that the minimum detected temperature T3ₘᵢₙ is less than the minimum printing initiation temperature; and
intermittently heating the head chip using the at least one auxiliary heater until the difference between the maximum detected temperature T3ₘₐₓ and the minimum detected temperature T3ₘᵢₙ is less than or equal to the predetermined temperature t3, and until the minimum detected temperature T3ₘᵢₙ is greater than or equal to the minimum printing initiation temperature.

32. The method of claim 30, further comprising:
determining that the minimum detected temperature T3ₘᵢₙ is greater than or equal to the minimum printing initiation temperature; and
printing an image.

33. A printing device head chip, comprising:
at least one nozzle array;
at least one auxiliary heater located at one end of the at least one nozzle array; and
a plurality of temperature sensors uniformly distributed along a length of the head chip.
